(19) United States
(12) Patent Application Publication
(10) Pub. No.: US 2025/0167470 A1
(43) Pub. Date: May 22, 2025

(54) ELECTRICAL CONTACT FOR MAKING AN ELECTRICAL CONNECTION WITH AN ELECTRICAL CONDUCTOR

(71) Applicant: TE Connectivity Solutions GmbH, Schaffhausen (CH)

(72) Inventors: Eric CHATELUS, Pontoise (FR); Stéphane GALLERAND, Pontoise (FR); Thibault VERNIER, Pontoise (FR); Olivier PAMART, Pontoise (FR); Youssef EL HAKMI, Pontoise (FR)

(21) Appl. No.: 18/953,369

(22) Filed: Nov. 20, 2024

(30) Foreign Application Priority Data
Nov. 21, 2023 (FR) 2312799

(51) Int. Cl. H01R 11/05; H01R 4/02; H01R 4/04

(52) U.S. Cl. CPC H01R 11/05; H01R 4/029; H01R 4/04

(57) ABSTRACT

An electrical contact includes a contact portion, a connection portion and a transition portion. The connection portion includes a contact surface, in particular a flat contact surface, configured for electrical connection with an electrical conductor. The transition portion is arranged between the contact surface and the connection portion along a longitudinal direction of the electrical contact. At least one first side wall protrudes from the contact surface and extends at least along the transition portion with respect to the longitudinal direction of the electrical contact.

### CROSS REFERENCE TO RELATED APPLICATIONS

This application claims the benefit of FR Application No. 2312799, filed 21 Nov. 2023, the subject matter of which is herein incorporated by reference in its entirety.

### BACKGROUND OF THE INVENTION

The subject matter herein relates to an electrical contact for making an electrical connection with an electrical conductor, such as a connector cable or a bus bar. The subject matter herein also relates to a connection assembly comprising an electrical contact and an electrical conductor.

In most applications, it is desirable to provide a stable and durable electrical connection between the electrical contact and a connector cable or a busbar. Ultrasonic welding, electrical resistance welding or induction welding are known methods for welding an electrical contact to a connector cable or a bus bar. Ultrasonic welding is a welding process using high-frequency vibrational energy. This is a solid-state welding process characterized in that the materials to be welded do not undergo melting, unlike electric resistance welding. Electrical resistance welding is carried out under pressure and with a strong electrical current. With induction welding, heat is induced electromagnetically in the electrical contact.

In the automotive industry for example, in particular for charging an electric vehicle, it is desirable to provide an electrical contact with a high current transmission capacity. Poor current transmission capacity could cause undesirable overheating of the electrical contact.

An electrical contact known in the prior art is illustrated in FIG. 1. The electrical contact 1 of FIG. 1 comprises a contact portion 2, a connection portion 3 and a transition portion 4 arranged between the contact portion 2 and the connection portion 3 along a longitudinal direction 100 of the electrical contact 1. The connection portion 3 comprises a flat contact surface 5. The end 6 of an electrical conductor 7 is welded by means of ultrasonic welding to the flat contact surface 5. The sectional view (FIG. 1A), transverse to the longitudinal direction 100, shows that the cross-section of the electrical contact 1 at this point is equivalent to the sum of the section A1 of the end 6 of the electrical conductor 7 and the section A2 of the connection portion 3. At the boundary between the connection portion 3 and the transition portion 4, the cross-section of the electrical contact 1 is only equal to the cross-section A2 of the connection portion 3, as shown by the sectional view (FIG. 1B) transverse to the longitudinal direction 100. In the example of FIG. 1, the cross-section is reduced by almost 50% between the sectional view (FIG. 1A) and the sectional view (FIG. 1B).

A too small cross section at the transition portion is undesirable because this might not allow a satisfactory transmission of current, especially high voltage direct current.

There is a need for an electrical contact for an electrical connection which is improved compared with the prior art.

### BRIEF DESCRIPTION OF THE INVENTION

In one embodiment, an electrical contact is provided including a contact portion, a connection portion, the connection portion comprising a flat contact surface configured for electrical connection with an electrical conductor, and a transition portion, the transition portion being arranged between the flat contact surface and the contact portion along a longitudinal direction of the electrical contact. At least one first side wall protrudes from the flat contact surface and extends at least along the transition portion with respect to the longitudinal direction of the electrical contact.

The feature of the side wall allows to increase the cross-section of the transition portion. The increasing of the cross-section allows to reduce the electrical resistance. The reduction in resistance allows to avoid overheating of the electrical contact during the passage of an electrical current. The transition portion is thus further adapted for the passage of a strong electric current.

The transition portion is defined as a portion that is adjacent to the contact surface. In particular, the contact surface and the transition portion are not superimposed, even partially, on each other. Only the contact surface of the connection portion can be configured to be in surface contact with an electrical conductor. In particular, the transition portion is not adapted to receive an electrical conductor. The transition portion may be configured so as not to be in surface contact with an electrical conductor when the electrical conductor is electrically connected to the electrical contact.

Increasing the cross-section at the transition portion is particularly advantageous because the electrical conductor would not contribute to the cross-section at this point since the transition portion is not configured to receive the electrical conductor.

The increasing of the cross-section at the transition portion allows to advantageously reduce the cross-section at the connection portion, since at the connection portion the cross-section of the electrical conductor contributes to the total cross-section. The possible reduction of the cross-section of the connection portion allows in particular to reduce the thickness of the connection portion at the flat contact surface. A thinned flat contact surface is, for example, advantageous to facilitate certain welding processes and/or to allow saving material.

In particular, the contact surface of the connection portion is limited to a flat surface. A flat surface is a surface such that a straight line passing through two of its points is entirely contained therein.

The side wall may be integrally connected to the transition portion. The side wall may protrude in an inclined manner with respect to the flat contact surface, in particular with an inclination of between 45° and 135°, more particularly with an inclination of between 80° and 95°. The side wall can protrude perpendicularly to the flat contact surface, i.e. with an inclination of 90°. Thus, the side wall may be parallel to a lateral side of a bus bar, for example. This can facilitate welding or gluing between parallel surfaces of the side wall and a lateral side of the bus bar.

In particular, the electrical contact is configured for electrical connection with a bus bar, comprising an insulating or non-insulating coating, by means of a welding process.

The connection portion may comprise an opposing surface that is geometrically opposite to the flat contact surface. The opposite surface may be flat. The opposite surface may be parallel to the flat contact surface. Alternatively, the opposite surface may be a curved surface.

According to one embodiment, the side wall may extend from the connection portion to the transition portion, in particular from a distal end of the connection portion to the transition portion. This may allow to improve the mechanical strength of the electrical connector.

According to one embodiment, the electrical contact may comprise a second side wall, and the two side walls may be arranged opposite each other respectively along the longitudinal direction of the electrical contact.

The presence of a second side wall allows to further increase the cross-section of the transition portion.

In addition, the two side walls may allow to guide a conductor cable or a bus bar to be welded inserted when the conductor cable or the bus bar is inserted between the two side walls.

The two side walls may be symmetrical to each other along the longitudinal direction. The electrical contact can be easily formed by a cold forming process.

At least one cross-section of the connection portion or the transition portion, or both, may have a “U” shape. The “U” shape refers to the shape of the letter “U” according to the Latin alphabet, wherein the central portion of the “U” shape is flat because it corresponds to the flat contact surface. This particular geometry allows to improve the mechanical strength of the electrical contact, which is, for example, particularly advantageous for better resisting the vibrations induced by ultrasonic welding. Ultrasonic welding can indeed involve frequencies between 20 and 70 kHz which generate strong mechanical vibrations in the electrical contact.

According to one embodiment, the largest cross-section of the electrical contact at the connection portion is equal to or smaller than the smallest cross-section of the transition portion. In particular, the largest cross-section of the electrical contact at the connection portion is strictly smaller than the smallest cross-section of the transition portion. It is thus possible to thin the electrical contact at the connection portion.

At least one portion of the transition portion may protrude from the contact portion and the connection portion. The at least one protruding portion can respectively form a support or a locking surface on which a connector housing, for example, can abut, in particular in the longitudinal direction. The at least one protruding portion may allow to maintain the connection device between a housing and a housing cover.

The transition portion may comprise a first portion. The first portion may have a solid and circular disc-shaped cross-section. The first portion may have a constant cross-section. The first portion may provide a surface adapted for a temperature measurement. The temperature measurement may be carried out by means of a temperature sensor. It is indeed sometimes necessary to monitor the temperature of an electrical contact, in particular when dealing with an electrical contact used for charging electric vehicles in a charging base. Alternatively or in combination, the first portion may provide a surface adapted to maintain the electrical contact during the ultrasonic welding process.

According to one embodiment, the flat contact surface may be configured to make an electrical connection with an electrical conductor by means of: laser welding, ultrasonic welding, electrical resistance welding, induction welding, or cold gluing with a conductive adhesive. The contact surface is particularly suitable for welding and gluing because it is flat. In particular, a flat contact surface is particularly desirable for ultrasonic welding.

The electrical contact can be configured for making an electrical connection without a crimping process.

According to one embodiment, the electrical contact may comprise a transition surface and at least one first locking surface, the first locking surface being substantially transverse to the flat contact surface, and the transition surface connecting the first locking surface to the flat contact surface.

The transition surface is bordered by the at least one side wall, in particular by the two side walls. The transition surface may be a flat surface. The transition surface may be formed by a descending slope from the transition portion to the flat contact surface. Alternatively, the transition surface may be a curved surface, or at least partially curved. The transition surface may be convex. The transition surface may be concave. This allows to save material.

The transition portion may comprise a second portion, wherein the second portion may be arranged between the first portion of the transition portion and the connection portion. The second portion of the transition portion may comprise the transition surface.

The locking surface may be formed by a protruding portion of the transition portion, in particular by a protruding portion of the first portion of the transition portion. The locking surface may be perpendicular to the flat contact surface.

According to one embodiment, the flat contact surface may be offset parallel with respect to a longitudinal central axis of the contact portion. This allows to align a central longitudinal axis of an electrical conductor connected to the contact surface with the longitudinal central axis of the contact portion. An alignment of the central longitudinal axis of the electrical conductor with that of the contact portion allows to obtain a more compact electrical contact. This alignment allows to reduce the size of a cavity of a sealing element in which the electrical conductor can be received.

According to one embodiment, the height of the side wall from the flat contact surface may vary at least partially in an increasing manner in a direction from the connection portion to the contact portion. Compared to a side wall having a constant height, this allows to reduce the height of the side wall and thus save material to form the electrical contact.

Alternatively, the height of the side wall from the flat contact surface may be constant in a direction from the connection area to the contact area. This allows to obtain an increase of the mechanical strength in a homogeneous manner along the longitudinal direction.

The contact portion may be configured to plug in with a mating electrical connector. The contact portion may be male or female. A male contact portion may be a pin. A female type contact portion may comprise a hollow tubular accommodation for receiving a mating male connector. According to one embodiment, the contact portion may be a solid contact pin. The contact pin may have a cylindrical shape. The contact pin may have one or more metal coatings. The contact pin may have several metal coatings of identical composition. Alternatively, the contact pin may have several metal coatings the composition of which is different from each other. As an example, the contact pin may have a silver coating and a nickel underlayer. The contact pin may have a galvanic coating comprising silver, gold or tin. The end of the contact portion may be provided with a cap. The cap allows to protect the end of the contact pin and reduces hazards to the touch. The cap thus provides finger protection, more commonly known as “touch-safe”. The cap may be detachably arranged at the contact portion. The cap may be made from a dielectric material, for example a plastic material.

Alternatively, the contact portion may be a contact socket. Unlike the solid contact pin which has a solid structure, the contact socket has a hollow structure. The hollow structure of the contact socket is adapted to receive an electrical conductor.

According to one embodiment, the electrical contact may be integrally formed as a single piece. This avoids assembly steps. The electrical connector may be formed from an electrically conductive material. The electrical connector may be formed from a metallic material. The electrical connector may be formed by a cold forming process. The electrical contact may be made of copper or a copper alloy, in particular a copper alloy with a high copper content. The use of copper is advantageous because of its very good electrical conductivity. The electrical contact may be made of aluminum or iron.

In an embodiment, a connection assembly is provided including an electrical contact according to at least one of the embodiments described above and an electrical conductor, in particular a conductor cable or a bus bar, in which the electrical conductor is welded or glued to the flat contact surface.

In particular, the conductor cable or the bus bar may only be welded or glued to the flat contact surface. The connection assembly may be characterized by a lack of welding between the at least one side wall and the conductor cable or the bus bar. This embodiment is particularly suitable for ultrasonic welding between the conductor cable or the bus bar and the electrical contact. The conductor cable or the busbar may be arranged in the connection portion in such a manner that each side wall is spaced apart from the conductor cable or the busbar. The greatest distance between the first side wall and the second side wall may be at least 5% and at most 30% greater than the transverse dimension of the conductor cable or the busbar in a plane parallel to the flat contact surface. The greatest distance between the first side wall and the second side wall may be greater than the diameter of the first portion of the transition portion. The first portion can be a cylindrical solid portion.

Alternatively, the conductor cable or the bus bar may be welded or glued to both the flat contact surface and at least one sidewall, particularly to both sidewalls. This advantageously allows to increase the contact surface between the conductor cable or the bus bar and the electrical contact. This embodiment is particularly suitable for electrical resistance welding between the conductor cable or the bus bar and the electrical contact.

In the connection assembly, a longitudinal central axis of the conductor cable or the bus bar may be aligned with a longitudinal central axis of the contact portion. This advantageously allows to reduce the bulk of the connection assembly. This alignment can be used to reduce the size of a cavity of a sealing element in which the conductor cable or the bus bar can be received.

A bus bar may be a metallic material in the form of a substantially rigid bar. The bus bar may have a solid cross-section. The bus bar may comprise at least one flat surface. The bus bar may have a rectangular cross-section. Alternatively, the bus bar may have a cylindrical shape. The bus bar may have a disc-shaped cross-section.

According to one embodiment, the connection assembly may comprise the electrical contact and a bus bar, in particular a bus bar comprising at least one flat face, more particularly a bus bar of rectangular cross-section.

A conductor cable may comprise a plurality of conductor metal strands, for example made of copper. The conductor cable may have a substantially circular cross-section prior to welding. The portion of the conductor cable welded to the flat contact surface may have a rectangular cross-section.

A cross-section of the transition portion corresponds to a surface of the transition portion in a plane perpendicular to the longitudinal direction of the electrical contact.

A cross-section of the connection portion corresponds to a surface of the connection portion in a plane perpendicular to the longitudinal direction of the electrical contact.

A cross-section of the contact portion corresponds to a surface of the contact portion in a plane perpendicular to the longitudinal direction of the electrical contact.

According to another aspect of the subject matter herein, an electrical contact is provided including a contact portion, a connection portion, the connection portion comprising a contact surface configured for electrical connection with an electrical conductor, and a transition portion, the transition portion being arranged between the contact surface and the contact portion along a longitudinal direction of the electrical contact. At least one first side wall protrudes from the contact surface and extends at least along the transition portion with respect to the longitudinal direction of the electrical contact.

According to one embodiment of this aspect, the contact surface may be a flat surface. A flat contact surface is adapted for making an electrical connection with a conductor cable, which can be flattened or pressed on said flat contact surface. A flat contact surface is particularly suitable for making an electrical connection with a busbar having at least one flat face.

Alternatively, according to another embodiment of this aspect, the contact surface may be a curved surface. A curved contact surface is suitable for making an electrical connection with a conductor cable. A curved contact surface is particularly suitable for making an electrical connection with a cylindrical bus bar, i.e. having a disc-shaped cross-section.

According to another aspect of the subject matter herein, a connection assembly is provided including a bus bar of cylindrical cross-section and an electrical contact. The electrical contact may comprise: a contact portion, a connection portion, the connection portion comprising a curved contact surface and a transition portion, the transition portion being arranged between the curved contact surface and the contact portion along a longitudinal direction of the electrical contact. At least one first side wall may protrude from the curved contact surface and extend at least along the transition portion relative to the longitudinal direction of the electrical contact. An electrical connection may be made between the electrical contact and the bus bar at the curved contact surface.

### BRIEF DESCRIPTION OF THE DRAWINGS

The invention and its advantages will be explained in more detail hereinafter by means of exemplary embodiments and based on the following accompanying figures, in which:

FIG. 1 schematically illustrates an electrical contact according to the prior art;

FIG. 1A schematically illustrates an electrical contact according to the prior art;

FIG. 1B schematically illustrates an electrical contact according to the prior art;

FIG. 2 schematically illustrates an electrical contact according to a first embodiment;

FIG. 3 schematically illustrates a connection assembly according to the first embodiment;

FIG. 3A schematically illustrates a connection assembly according to the first embodiment;

FIG. 3B schematically illustrates a connection assembly according to the first embodiment;

FIG. 4 schematically illustrates an electrical contact according to a second embodiment;

FIG. 5 schematically illustrates an electrical contact according to a third embodiment;

FIG. 6 schematically illustrates an electrical contact according to a fourth embodiment;

FIG. 7 schematically illustrates an electrical contact according to a fifth embodiment;

FIG. 8 schematically illustrates a partial and sectional view of a connector housing comprising two electrical connectors according to the first embodiment.

### DETAILED DESCRIPTION OF THE INVENTION

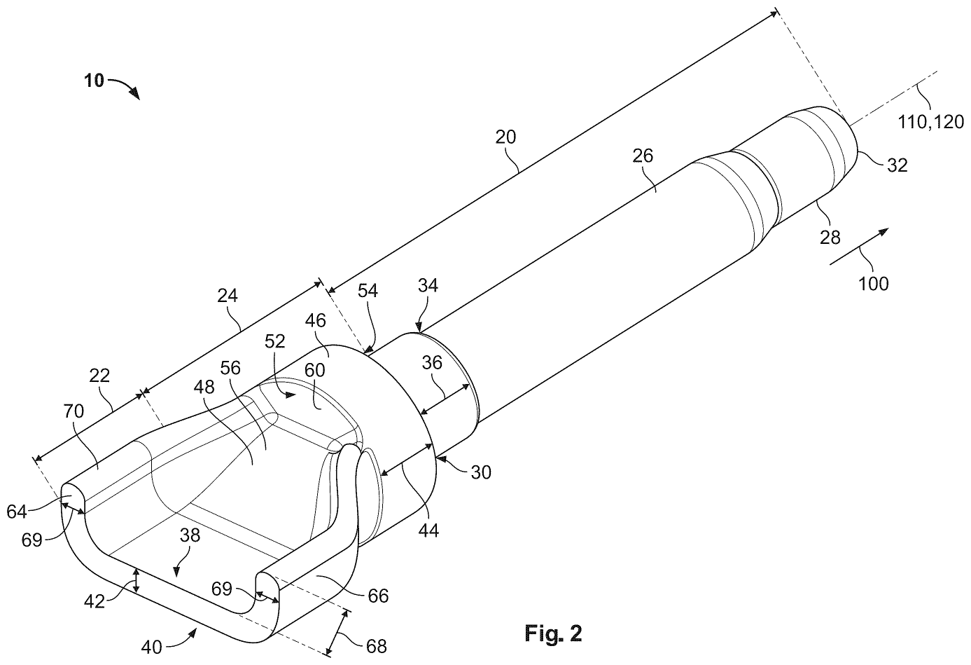

FIG. 2 schematically illustrates an electrical contact 10 according to a first embodiment. The electrical contact 10 is made from an electrically conductive material. The electrical contact 10 may be integrally formed as a single piece of metal. The electrical contact 10 comprises three portions along a longitudinal direction 100: a contact portion 20, a connection portion 22 and a transition portion 24. The transition portion 24 is arranged between the contact portion 20 and the connection portion 22 along a longitudinal direction 100.

The contact portion 20 can be plugged into a mating electrical contact (not shown), in particular in the longitudinal direction 100. In the illustrated example, the contact portion 20 is a contact pin 26, more commonly known as a “pin contact”. The contact pin 26 has a substantially cylindrical shape and a substantially circular cross-section. The contact pin 26 has a longitudinal central axis 110. The longitudinal central axis 110 is parallel to the longitudinal direction 100. The contact pin 26 has a solid structure.

The contact pin 26 extends between a first end 30 and a second end 32 opposite to the first end 30 with respect to the longitudinal direction 100. The first end 30 is connected to the transition portion 24. The second end 32 may be provided with a cap 28, as illustrated in the example of FIG. 2.

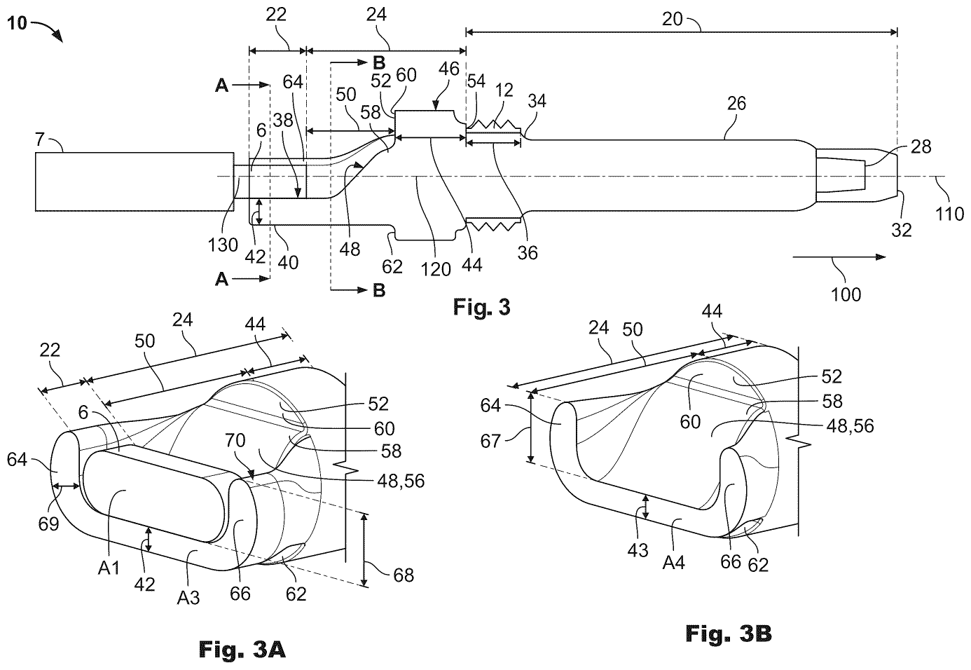

The contact pin 26 may comprise a circumferential shoulder 34. In particular, the contact pin 26 may comprise a single circumferential shoulder 34 over its length. The presence of the circumferential shoulder 34 forms a segment 36 between the first end 30 and the circumferential shoulder 34. A cross-section at the segment 36 is larger than a cross-section at the rest of the contact pin 26. The segment 36 of the contact pin 26 is configured to receive a seal 12 (shown in FIG. 3), in particular an annular seal 12. The seal 12 may have an inner diameter approximately equal to the outer diameter of the segment 36. The seal 12 may be frictionally held to the segment 36.

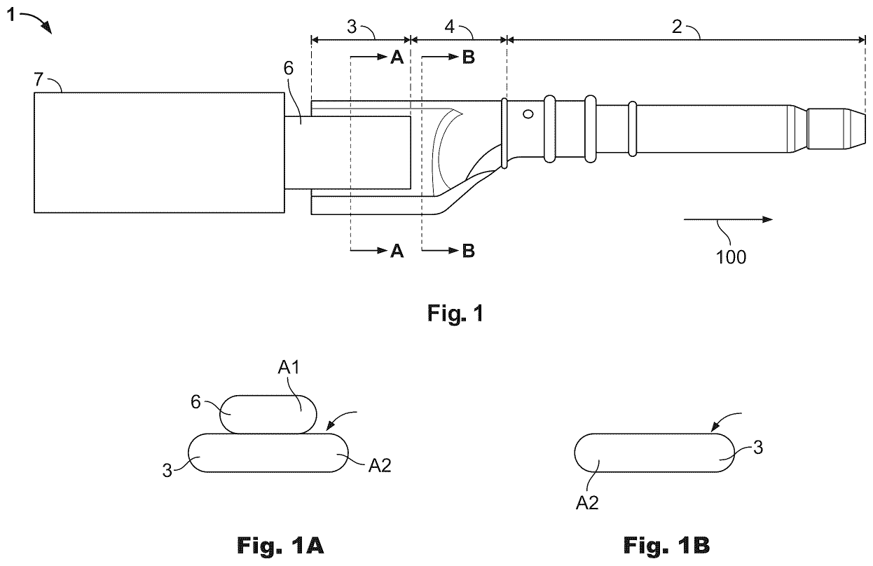

The contact portion 20 may be characterized by the absence of collars. A collar may be formed between two successive circumferential shoulders. For example, three successive collars are visible on the contact portion 2 of the electrical contact 1 according to the prior art (cf. FIG. 1). The presence of a single circumferential shoulder 34 on the contact portion 20 advantageously allows to reduce the length of the contact portion 20 while allowing satisfactory holding of the seal 12. It is understood that the length of the contact portion is defined from the longitudinal central axis 110.

The connection portion 22 is configured to make an electrical connection, in particular an electrical connection and a mechanical connection, with an electrical conductor (shown in FIG. 3). The connection portion 22 has a contact surface 38. The contact surface 38 is configured for electrical connection with an electrical conductor (shown in FIG. 3) by means of welding or gluing. The contact surface 38 is flat. The flat contact surface 38 may have a rectangular shape. The flat contact surface 38 may have a surface area of between 5 square millimeters and 1000 square millimeters, in particular between 50 square millimeters and 250 square millimeters. The flat contact surface 38 serves as a support for welding or gluing with an electrical conductor. An electrical conductor, in particular a rigid bus bar, may be placed, preferably flat, on the flat contact surface 38.

When the electrical connection is made by using an ultrasonic welding process, an active part of a sonotrode may be brought above the bus bar and send vibrations to weld the bus bar with the electrical contact 10 at the flat contact surface 38.

FIG. 3 illustrates a longitudinal sectional view of the electrical contact 10 and two cross-sectional views of the electrical contact 10. FIG. 3 also shows an electrical conductor 7 the end 6 of which is arranged on the flat contact surface 38 of the electrical contact 10. The electrical contact 10 and the electrical conductor 7 form a connection assembly. In what follows, reference is made to FIGS. 2 and 3.

The connection portion 22 comprises a second surface 40, opposite to the flat contact surface 38. In the example of FIG. 2, the second surface 40 is a flat surface. The flat contact surface 38 and the second surface 40 are parallel to each other and to the longitudinal direction 100. The distance between the flat contact surface 38 and the second surface 40, in other words the thickness of the connection portion 22, is indicated by the reference sign 42 in FIGS. 2 and 3.

The transition portion 24 comprises a first portion 44 and a second portion 50.

The first portion 44 has a cylindrical shape defined by an outer circumferential wall 46 which extends between a first circular base 52 and a second circular base 54. The first portion 44 has a disc-shaped cross-section. In other words, the first portion 44 has a solid structure. The first portion 44 has a longitudinal central axis 120. The longitudinal central axis 120 of the first portion 44 is aligned with the longitudinal central axis 110 of the contact portion 20. The contact portion 20 is directly adjacent to the second circular base 54. The diameter of the first portion 44 is greater than the diameter of the contact pin 26. The diameter of the first portion 44 corresponds to the diameter of the first circular base 52, respectively to the diameter of the second circular base 54. The thickness of the first portion 44 corresponds to the distance between the first circular base 52 and the second circular base 54. The thickness of the first portion 44 may be adapted to allow a temperature measurement on the circumferential wall 46 of the transition portion 24, in particular to monitor the temperature of the electrical contact 100 when an electrical current flows through it. The thickness of the first portion 44 may be adapted to make it easier to manipulate the electrical contact 100 during the welding or gluing process, or when assembling the electrical contact 100 in a connector housing, or both.

The second portion 50 (see FIG. 3) connects the connection portion 22 to the first circular base 52 of the first portion 44. In the example illustrated, the first circular base 52 is perpendicular to the flat contact surface 38. In the example illustrated, the second portion has a solid structure, as illustrated by the sectional view of FIG. 3.

The second portion 50 comprises a transition surface 48. In the first embodiment, the transition surface 48 defines a slope 56, in particular a slope of 30° to 45° with respect to the flat contact surface 38. The slope 56 may have a roundness 58, in particular towards the top of the slope 56 (shown in FIG. 3). The slope 56 is descending in a direction from the transition portion 24 toward the flat contact surface 38. The transition surface 48 is inclined relative to the first circular base 52.

The second portion 44 protrudes relative to the first portion 50. The at least one protruding surface of the second portion 44 can respectively serve as a locking surface by forming an abutment surface for a connector housing for example. A locking lance of a connector housing may abut on the locking surface, which is further described in the following paragraph. Involuntary rotation, involuntary translational movement, or both, of the electrical contact 100 can be avoided. The first circular base 52 of the first portion 44 may comprise a first locking surface 60. The first locking surface 60 is a flat surface. The first locking surface 60 is oriented towards the flat contact surface 38. The transition surface 48 connects the first locking surface 60 to the flat contact surface 38.

The first circular base 52 of the first portion 44 may comprise a second locking surface 62 (shown in FIG. 3). The second locking surface 62 is a flat surface. The second locking surface 62 is oriented towards the second surface 40.

In another embodiment, the first circular base 52 of the transition portion 24 may have a single locking surface, or no locking surface.

The flat contact surface 38 is arranged parallel to and offset from the longitudinal central axis 110 of the contact portion 20 and the longitudinal central axis 120 of the transition portion 24. Thus, the flat contact surface 38 is placed eccentrically with respect to the first circular base 52 of the first portion 44. This offset of the flat contact surface 38 allows a longitudinal central axis 130 of an electrical conductor to be aligned with the longitudinal central axis 110 of the contact portion 20 and the longitudinal central axis 120 of the transition portion 24 (shown in FIG. 3). This arrangement allows to reduce the bulk of the electrical contact 10.

Unlike the electrical contact 1 according to the prior art (cf. FIG. 1), the electrical contact 10 further comprises two side walls 64, 66. In the first embodiment, the side walls 64, 66 are symmetrical with each other. Thus, in what follows, the description of the lateral wall 64 also applies to the lateral wall 66.

The side wall 64 protrudes from the flat contact surface 38. In particular, the side wall 64 protrudes perpendicularly to the flat contact surface 38. The lateral wall 64 extends along the longitudinal direction 100 of the electrical contact 10 and is connected to the transition portion 24, in particular to the first circular base 52 of the first portion 44. The two side walls 64, 66 extend on either side of the second portion 50 of the transition portion 24. The transition surface 48 is thus at least partially bordered respectively by the side walls 64, 66. The lateral wall 64 has a free edge 70. The free edge 70 may be rounded.

At the connection portion 22, as illustrated in FIG. 3A, the side wall 64 has a height 68 defined between the flat contact surface 38 and a free edge 70. In this example, the height 68 is defined along a direction perpendicular to the flat contact surface 38. The height 68 of the side wall 64 may be between 1 millimeter and 50 millimeters. The height 68 of the side wall 64 may be greater than the thickness 42 of the connection portion 22. In addition, at the connection portion 22, the side wall 64 has a thickness 69 defined in a direction parallel to the flat contact surface 38, as shown in FIG. 2 and view (A) of FIG. 3. The thickness 69 may be substantially the same as the thickness 42. Preferably, the thickness 69 may be greater than the thickness 42.

At the first portion 50, as illustrated in FIG. 3B, the side wall 64 has a height 67. The height 67 may be substantially equal to the height 68.

The first portion 50 has a thickness 43, as shown by view (B) in FIG. 3. The thickness 43 of the second portion 50 may be substantially the same as the thickness 42 of the connection portion 22. Preferably, the thickness 43 of the second portion 50 may be greater than the thickness 42 of the connection portion 22. This allows to provide an electrical contact having a connection portion 22 that is thinner than the second portion 50.

The two side walls 64, 66 are arranged opposite each other respectively along one side of the flat contact surface 38 in the longitudinal direction 100 of the electrical contact 10. At the connection portion 22, the presence of the two side walls 64, 66 confers a cross-section in the form of “U”. The “U” shape refers to the shape of the letter “U” according to the Latin alphabet, wherein the central portion of the “U” shape is flat because it corresponds to the flat contact surface 38.

The sectional view (A) of FIG. 3, transverse to the longitudinal direction 100, shows that the cross-section of the electrical contact 10 at this point is equivalent to the sum of the cross-section A1 of the end 6 of the electrical conductor 7 and the cross-section A3 of the connection portion 22. The cross-section A3 of the connection portion 22 comprises the thickness cross section 42 as well as the cross-section of each of the side walls 64, 66. The cross-section A3 of the electrical contact 10 is larger than the cross-section A2 of the electrical contact 1 according to the prior art illustrated in FIG. 1 and which does not comprise side walls. Increasing the cross-section allows to reduce the electrical resistance. The reduction in resistance allows to avoid overheating of the electrical contact during the passage of an electrical current.

Advantageously, the side walls 64, 66 allows in particular to increase the cross-section of the electrical contact 10 in the transition portion 24, in particular at the second portion 50 of the transition portion 24. The sectional view (B) of FIG. 3 illustrates the second portion 50, which is a portion beyond which the end 6 of the electrical conductor 7 does not extend. At this point (see sectional view (B) of the Figure), the cross-section of the electrical contact 10 is defined only by the cross-section A4 of the second portion 50 of the transition portion 24.

The cross-section A4 of the electrical contact 10 is larger than the cross-section A2 of the electrical contact 1 according to the prior art illustrated in FIG. 1 and which does not comprise side walls.

The cross-section A4 of the transition portion 24 may be substantially equal to the cross-section A3 of the connection portion 22. Preferably, the cross-section A4 of the transition portion 24 is greater, in particular strictly greater, than the cross-section A3 of the connection portion 22.

In particular, the sum of the cross-sections A1 and A3 is at most two times greater, in particular at most 1.5 times greater, than the cross section A4. This prevents the cross-section A4 of the electrical connector 10 at the transition portion 24 from being too small compared with the cross-section (A1+A3) at the connection portion 22, to which the cross-section A1 of the electrical conductor 6 contributes.

Better continuity in the transmission of electrical current can be achieved, in particular at the second portion 50 of the transition portion 24, i.e. beyond which the end 6 of the electrical conductor 7 does not extend, and therefore at the level of which the electrical conductor 7 does not contribute to the cross-section that can conduct the current.

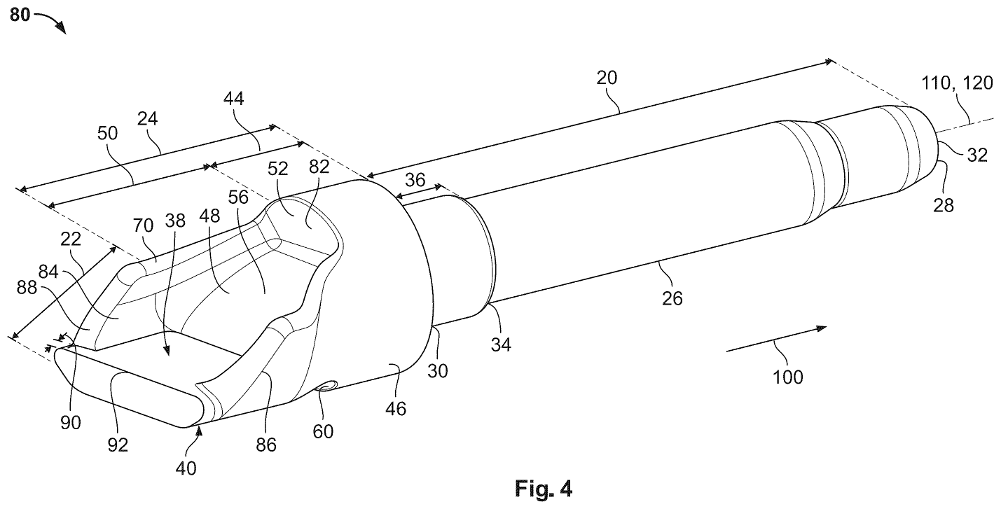

FIG. 4 diagrammatically illustrates an electrical contact 80 according to a second embodiment. In what follows, the elements having the same reference signs as those described above will not be described again and reference is made to their description made in the preceding paragraphs.

The electrical contact 80 according to the second embodiment differs from the first embodiment in that a first locking surface 82 formed by a flat portion of the first circular base 52 of the transition portion 24 is larger than the first locking surface 60 in the first embodiment. In the second embodiment, the inclination of the slope 56 of the transition surface 48 may be reduced compared to the first embodiment.

In the first embodiment, the height 68 of the side walls 64, 66 is constant along the flat contact surface 38. The electrical contact 80 according to the second embodiment differs from the first embodiment in that the height of each side wall 84, 86 from the flat contact surface 38 varies at least partially in an increasing manner in a direction from the connection portion 22 to the transition portion 24. In the second embodiment, a ramp 88 connects the flat contact surface 38 to each corresponding free edge 70. The volume of material required to manufacture the walls 84, 86 in the second embodiment is therefore less than the volume of material required to manufacture the walls 64, 66 in the first embodiment.

In the second embodiment, each of the side walls 84, 86 may be spaced a distance 90 from a distal end 92 of the connection portion 22 in the plane of the contact surface 38. The distal end 92 corresponds to the outermost free edge of the flat contact surface 38. A cross-section of the connection portion 22 at the distal end 92 may have a trapezoidal shape, as illustrated in FIG. 4.

The electrical contact 80 according to the second embodiment allows to reduce the quantity of material required to manufacture the electrical contact while ensuring continuity of satisfactory transmission because a cross-section A4 of the transition portion 24, i.e. at the second portion 50 of the transition portion 24, is at least substantially the same as in the first embodiment at the section represented in view (B) of FIG. 3.

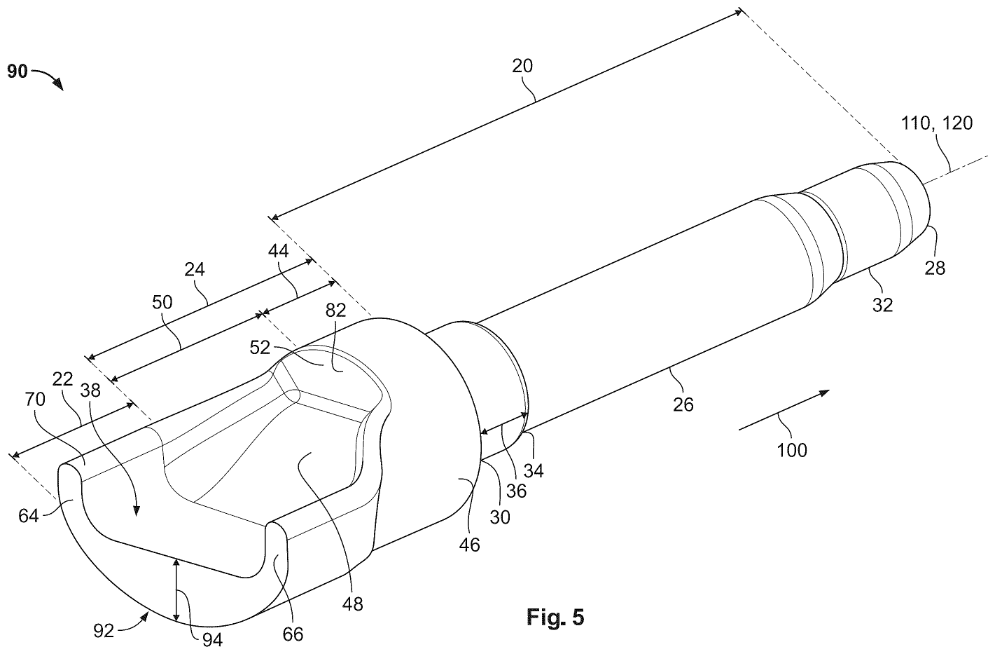

FIG. 5 schematically illustrates an electrical contact 90 according to a third embodiment. In what follows, the elements having the same reference signs as those described above will not be described again and reference is made to their description made in the preceding paragraphs.

The electrical contact 90 according to the third embodiment differs from the first embodiment and the second embodiment, respectively, in that, in the connection portion 22, the second surface 92 opposite to the flat contact surface 38 is a second convex surface 92. In other words, the second surface 92 is a curved surface while the second surface 40 is a flat surface. Unlike the thickness 42 which is homogeneous in the first embodiment, a thickness 94 between the contact surface 38 and the second convex surface 92 varies between the two walls 64, 66 in a plane perpendicular to the contact surface 38.

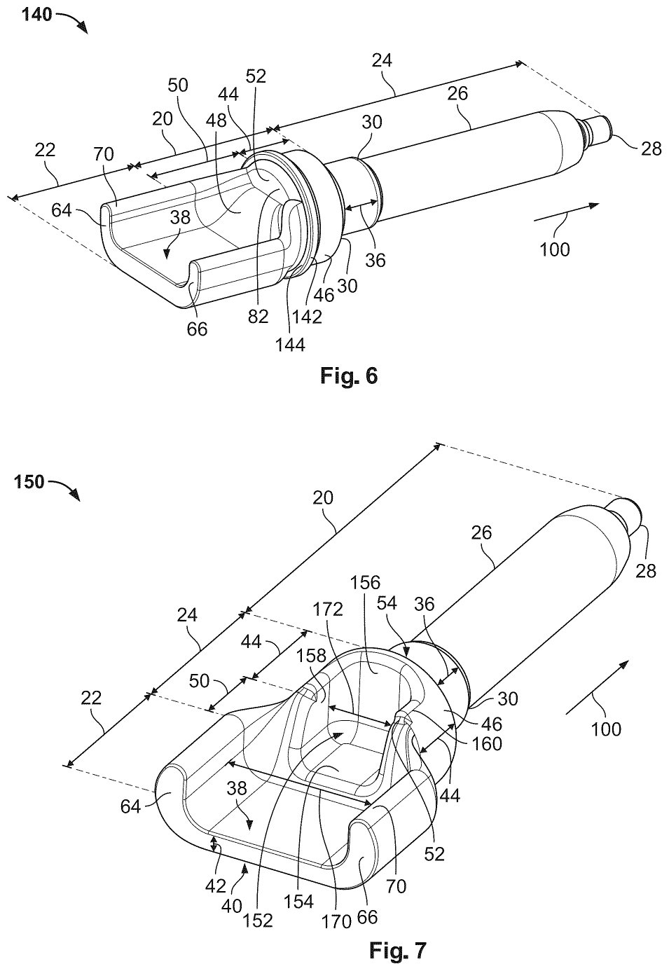

FIG. 6 schematically illustrates an electrical contact 140 according to a fourth embodiment. In what follows, the elements having the same reference signs as those described above will not be described again and reference is made to their description made in the preceding paragraphs.

The electrical contact 140 according to the fourth embodiment differs from the first embodiment in that a first locking surface 82 formed by a flat portion of the first circular base 52 of the transition portion 24 is larger than the first locking surface 60 according to the first embodiment. In the fourth embodiment, the inclination of the slope 56 of the transition surface 48 may be reduced with respect to the first embodiment.

The first locking surface 82 in the fourth embodiment may be substantially identical to the first locking surface 82 in the second embodiment and the third embodiment, respectively.

The electrical contact 140 according to the fourth embodiment differs from the first embodiment, the second embodiment and the third embodiment, respectively, in that the transition portion 24, in particular the first portion 44 of the transition portion 24, is provided with a flange 142. The flange 142 is arranged on the outer circumferential wall 46 of the transition portion 24. The flange 142 defines a bearing surface 144. The bearing surface 144 is a flat surface. The bearing surface 144 may be parallel to the first circular base 52. Alternatively, the bearing surface 144 may be inclined with respect to the plane of the first circular base 52. The bearing surface 144 of the flange 142 may be used to retain the electrical contact 140 in a connector housing, in particular in a direction from the contact portion 20 to the connection portion 22. The bearing surface 144 may be configured to abut against an element of the connector housing. The holding of the electrical contact 140 in a connector housing can thus be improved by means of the flange 142.

FIG. 7 schematically illustrates an electrical contact 150 according to a fifth embodiment. In what follows, the elements having the same reference signs as those described above will not be described again and reference is made to their description made in the preceding paragraphs.

The electrical contact 150 differs from the electrical contacts, respectively, according to the preceding embodiments in that the transition portion 24 comprises a recess 152. The characteristic of the recess 152 allows to save material for the manufacture of the electrical contact. In particular, the volume of material of the transition portion 24 according to the fifth embodiment is smaller than the volume of material of the transition portion 24 according to the other embodiments described above.

The recess 152 partially extends into the first portion 44. The recess 152 partially extends into the second portion 50. A bottom 154 of the recess 152 defines a flat surface parallel to the contact surface 38. The bottom 154 of the recess 152 may serve as a transition surface between the connection portion 22 and the transition portion 24. Thus, unlike the previous embodiments, the transition surface, i.e. the bottom 154 in the fifth embodiment, is parallel to the contact surface 38. In the preceding embodiments, the transition surface 48 is inclined with respect to the contact surface 38.

The bottom 154 of the recess 152 extends to a wall 156 of the second portion 44 of the transition portion 24. The wall 156 may be substantially parallel to the second circular base 54. Alternatively, the wall 156 may be inclined with respect to the plane of the circular base 54.

Due to the presence of the recess 152, the transition portion 24 is provided with two side walls 158, 160 which extend respectively along the longitudinal direction 100. An outer face of each side wall 158, 160 respectively corresponds to a portion of the outer circumferential wall 46. The transition portion 24 has a substantially U-shaped cross-section, at least as far as the wall 156. Beyond the wall 156, the first portion 44 of the transition portion 24 has a cylindrical cross-section. The side walls 158, 160, in addition to the side walls 64, 66, contribute to the transmission of current in the transition portion 24. The characteristic of the recess 152 allows to save material while ensuring satisfactory current transmission in the transition portion 24.

The thickness 42 of the connection portion 22 may be less than the thickness of the bottom 154 of the recess 152. This difference in thickness may form a shoulder between the contact surface 38 and the bottom 154 of the recess 152.

As illustrated in FIG. 7, a distance 170 between the side walls 64, 66 at the connection portion 22 is greater, in particular between 1.2 and 1.5 times greater, than a distance 172 between the side walls 158, 160. The distance 170 is defined parallel to the contact surface 38. The distance 172 is defined parallel to the bottom 154 of the recess 152. The characteristic of the recess 152 can simplify the form factor of the electrical contact 150 by facilitating the transition between the U-shaped connection portion 22 and the cylindrical portion of the second portion 44.

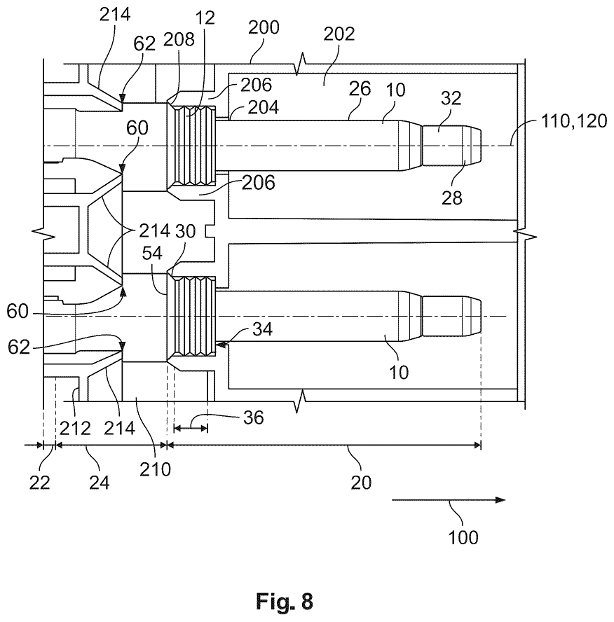

FIG. 8 schematically illustrates a sectional view of a connector housing 200 comprising two electrical connectors 10. FIG. 8 illustrates only a partial view of the connector housing 200. In what follows, the elements having the same reference signs as those described above will not be described again and reference is made to their description made in the preceding paragraphs.

The connector housing 200 may be manufactured of plastic, particularly from a plastic injection moulding process. The connector housing 200 comprises a respective accommodation 202 for receiving each contact pin 26 of the electrical connectors 10. Each accommodation 202 comprises an opening 204 through which the contact pin 26 is inserted, in particular in the longitudinal direction 100. The opening 204 may have a circular shape. The size of the opening 204 is complementary to the diameter of the contact pin 26, in particular to the diameter of the contact pin 26 between the circumferential shoulder 34 and the end 28. The segment 36 of the contact pin 26 may have a larger diameter than the opening 204. Thus, an insertion of the contact pin 26 in the longitudinal direction 100 can be blocked by an abutment on the shoulder 34. Alternatively or in combination, the seal 12 arranged on the circumference of the segment 36 may block the insertion of the contact pin 26 further to the accommodation 202.

The seal 12 provides a seal between the accommodation 202 and the opening 204. The seal 12 is arranged between a tubular chimney 206 of the housing 200 and the segment 36 of the contact pin 26. The tubular chimney 206 extends from the opening 204 parallel to the longitudinal direction 100 and in a direction from the contact portion 20 to the connection portion 22. The tubular chimney 206 has a circumferential edge 208. The circumferential edge 208 may rest on the second circular base 54 of the transition portion 24 of the electrical contact 10. In particular, the circumferential edge 208 may rest on a chamfer or a fillet defined between the second circular base 54 and the segment 36 of the contact pin 26. In the example shown in FIG. 8, the segment 36 of the contact pin 26 is covered by the seal 12.

The housing 200 comprises an interface 210 through which the electrical connectors 10 are inserted. The interface 210 may be covered by a cover 212. The cover 212 comprises locking lances 214 which abut respectively on the first locking surface 60 and the second locking surface 62 of each electrical contact 10. The respective abutment of the locking lances 214 against the locking surfaces 62, 64 allows to improve the holding of each electrical contact 10 in the connector housing 200.

The above description applies to each of the electrical connectors 10 and each of the housings 202, which are identical. The number of accommodations 202 in the connector housing 200 is not limiting. The connector housing 200 may be adapted to receive the electrical contact 80 according to the second embodiment. The connector housing 200 may be adapted to receive the electrical contact 90 according to the third embodiment. The connector housing 200 may be adapted to receive the electrical contact according to the fourth embodiment. The connector housing 200 may be adapted to receive the electrical contact according to the fifth embodiment.

In each of the embodiments, the connection portion 22 may be configured such that only the contact surface 38 is weldable or glueable to an electrical conductor. Alternatively, the connection portion 22 may be configured such that the contact surface 38 and at least one of the side walls 64, 66 are weldable or glueable to an electrical conductor

All the embodiments described above are not limiting but serve as examples illustrating the characteristics and advantages of the invention. It is understood that all or some of the features described above may also be combined in different ways. It should be noted that an individual characteristic described in relation to one embodiment may be combined with another embodiment.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112 (f), unless and until such claim limitations expressly use the phrase “means for” followed by a statement of function void of further structure.

What is claimed is:

1. An electrical contact comprising:
a contact portion,
a connection portion,
the connection portion comprising a flat contact surface configured for electrical connection with an electrical conductor, and
a transition portion,
the transition portion being arranged between the flat contact surface and the contact portion along a longitudinal direction of the electrical contact,
wherein at least one first side wall protrudes from the flat contact surface and extends at least along the transition portion with respect to the longitudinal direction of the electrical contact.

2. The electrical contact according to claim 1, comprising a second side wall, and the two side walls are arranged opposite each other respectively along the longitudinal direction of the electrical contact.

3. The electrical contact according to claim 1, wherein the largest cross-section of the electrical contact at the connection portion is equal to or smaller than the smallest cross-section of the transition portion.

4. The electrical contact according to claim 1, wherein the flat contact surface is configured to make an electrical connection with an electrical conductor by means of:
laser welding,
ultrasonic welding,
electric resistance welding,
induction welding, or
cold gluing with a conductive adhesive.

5. The electrical contact according to claim 1, comprising a transition surface and at least one first locking surface, the first locking surface being substantially transverse to the flat contact surface, and the transition surface connecting the first locking surface to the flat contact surface.

6. The electrical contact according to claim 1, wherein the flat contact surface is offset parallel to a longitudinal central axis of the contact portion.

7. The electrical contact according to claim 1, wherein the height of the side wall from the flat contact surface varies at least partially in an increasing manner in a direction from the connection portion to the transition portion.

8. The electrical contact according to claim 1, wherein the contact portion is a solid contact pin.

9. The electrical contact according to claim 1, wherein the contact portion, the connection portion and the transition portion are integrally formed as a single piece.

10. Connection assembly comprising:
an electrical contact including a contact portion, a connection portion, and a transition portion, the connection portion including a flat contact surface configured for electrical connection with an electrical conductor, the transition portion being arranged between the flat contact surface and the contact portion along a longitudinal direction of the electrical contact, wherein at least one first side wall protrudes from the flat contact surface and extends at least along the transition portion with respect to the longitudinal direction of the electrical contact; and
an electrical conductor comprising at least one of a conductor cable or a bus bar, wherein the electrical conductor is at least one of welded or glued to the flat contact surface

11. The connection assembly according to claim 10, wherein the electrical conductor is at least one of welded or glued only to the flat contact surface.

12. The connection assembly according to claim 10, comprising a second side wall, and the two side walls are arranged opposite each other respectively along the longitudinal direction of the electrical contact.

13. The connection assembly according to claim 10, wherein the largest cross-section of the electrical contact at the connection portion is equal to or smaller than the smallest cross-section of the transition portion.

14. The connection assembly according to claim 10, wherein the flat contact surface is configured to make an electrical connection with an electrical conductor by means of:
laser welding,
ultrasonic welding,
electric resistance welding,
induction welding, or
cold gluing with a conductive adhesive.

15. The connection assembly according to claim 10, comprising a transition surface and at least one first locking surface, the first locking surface being substantially transverse to the flat contact surface, and the transition surface connecting the first locking surface to the flat contact surface.

16. The connection assembly according to claim 10, wherein the flat contact surface is offset parallel to a longitudinal central axis of the contact portion.

17. The connection assembly according to claim 10, wherein the height of the side wall from the flat contact surface varies at least partially in an increasing manner in a direction from the connection portion to the transition portion.

18. The connection assembly according to claim 10, wherein the contact portion is a solid contact pin.

19. The connection assembly according to claim 10, wherein the contact portion, the connection portion and the transition portion are integrally formed as a single piece.
